(19) United States
(12) Patent Application Publication
(10) Pub. No.: US 2004/0129110 A1
(43) Pub. Date: Jul. 8, 2004

(54) Pedal having two treading surfaces

(76) Inventor: Wen-Hwa Lin, Taichung (TW)

Correspondence Address: Wen-Hwa Lin, 235 Chung-Ho, Box 8-24, Taipei, TW

(21) Appl. No.: 10/336,680

(22) Filed: Jan. 6, 2003

(51) Int. Cl. G05G 1/14

(52) U.S. Cl. 74/594.4

(57) ABSTRACT

A pedal having two treading surfaces comprises a pedal body, retaining pieces, and an elastic positioning device. A front end and a rear end of the pedal body are formed as a receiving portion. The two retaining pieces are pivotally installed at a receiving portion at two opposite sides of the pedal body. Each retaining piece has three operation surfaces The first operation surface and second operation surface are at two opposite sides. The third operation surface is between the first operation surface and the second operation surface. The elastic positioning device is formed by a positioning piece and two elastomers. The positioning piece is locked to the receiving portion by the screw. A screw rod passes through the two elastomers so that the two elastomers are pivotally installed in the retaining piece. By above components, a pedal having two treading surfaces are assembled with less components.

### FIELD OF THE INVENTION

The present invention relates to pedals, and particularly to a pedal having two treading surfaces, which is made with less components.

### BACKGROUND OF THE INVENTION

In general competitive used bicycle has a pedal with one treading surface or two treading surfaces. Referring to FIG. 1, a pedal of single treading surface is illustrated. A pedal with one treading surface is illustrated. The pedal is formed by a pedal body, a main buckle, an auxiliary buckle, and an elastic device. The main buckle is locked to a front surface of the pedal body. A front end thereof is protruded with a buckling portion and two positioning portions and a rear end thereof is formed with an auxiliary positioning portion. The auxiliary buckle is pivotally installed to a rear side of the pedal body and has a stopper protruded thereon. The stopper is parallel to the buckle for connection. The elastic device is installed between the auxiliary buckle and the pedal body. This single surface pedal is difficult in assembly and thus the cost in assembly is high.

Referring to FIG. 2, a pedal with two treading surfaces is illustrated. In that, many of the components of the single surface pedal are doubled and are assembled to two surfaces of the pedal body. As a consequence more components are necessary and the structure is complicated. As a result, the cost is high. Moreover, efficiency in manufacturing is low.

### SUMMARY OF THE INVENTION

Accordingly, the primary object of the present invention is to provide a pedal having two treading surfaces. The pedal comprises a pedal body, wherein each of a front end and a rear end of the pedal body is installed with a retaining piece, and an elastic positioning device. A front end and a rear end of the pedal body are formed as a receiving portion. The two retaining pieces are pivotally installed at the receiving portion at two opposite sides of the pedal body by using respective screw rods. Each retaining piece has three operation surfaces, a first operation surface, a second operation surface, and a third operation surface. The first operation surface and second operation surface are at two opposite sides. A middle section of the first operation surface is a main buckle with a concave edge. Two sides of the main buckle have two auxiliary buckles. The second operation surface is bent as a stopper. The third operation surface is between the first operation surface and the second operation surface. A plurality of hollow portions are formed in the third operation surface and a through hole. The elastic positioning device is formed by a positioning piece and two elastomers. The positioning piece is like a long strip. The positioning piece is locked to the receiving portion of the pedal body by the screw. A screw rod passes through the two elastomers so that the two elastomers are pivotally installed in the retaining piece. By above. components, a pedal having two treading surfaces can be assembled with less components.

The various objects and advantages of the present invention will be more readily understood from the following detailed description when read in conjunction with the appended drawing.

### BRIEF DESCRIPTION OF THE DRAWINGS

FIG. 1 is a perspective view of a prior art pedal with single one treading surface.

FIG. 2 is a perspective view of a prior art pedal with double treading surfaces.

FIG. 3 is a schematic perspective view of the present invention.

FIG. 4 is an assembled perspective view of the present invention.

FIG. 5 is a lateral schematic view of the present invention.

FIG. 6 is an assembled cross sectional view of the present invention.

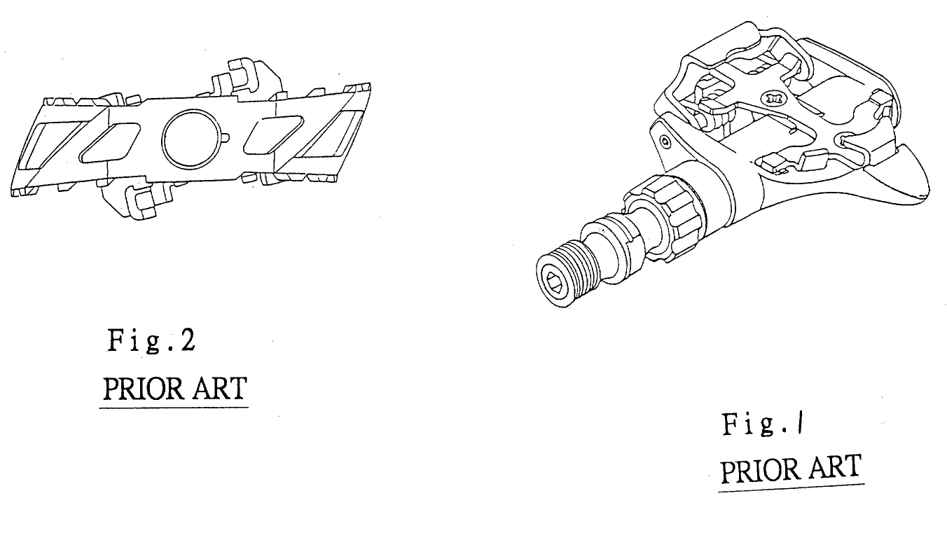

### DETAILED DESCRIPTION OF THE PREFERRED EMBODIMENTS

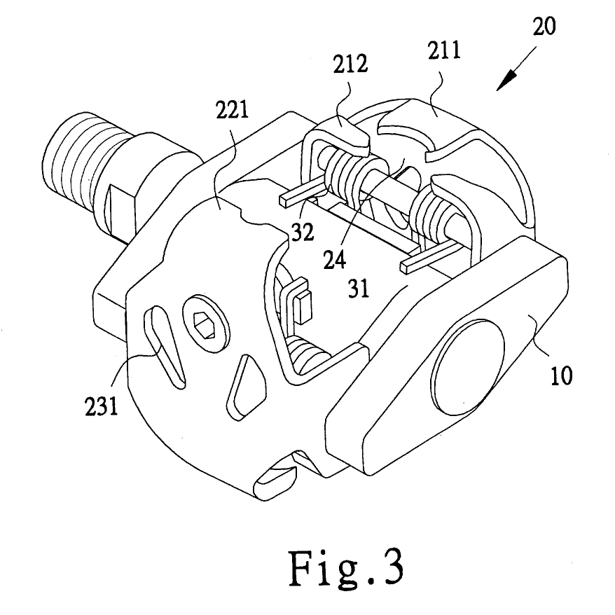

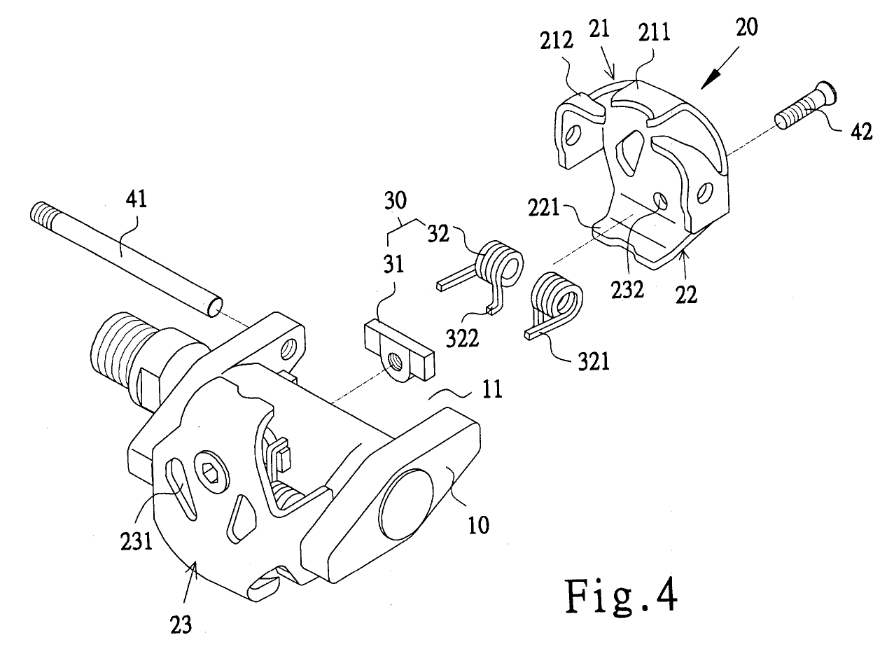

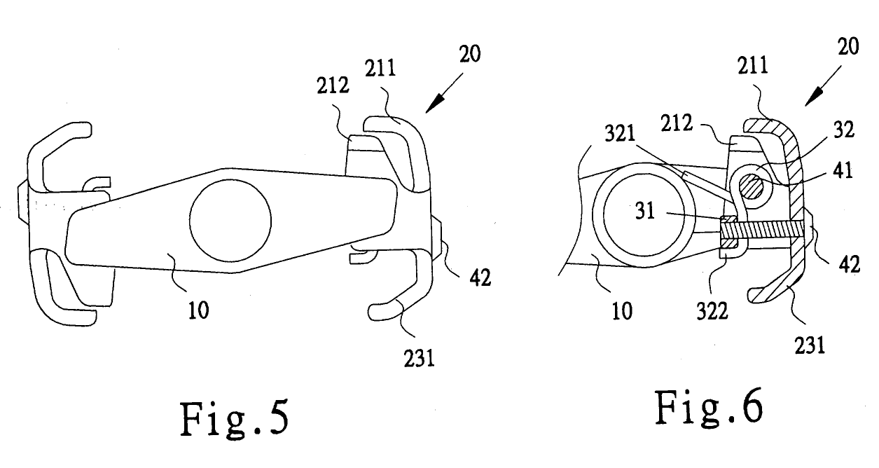

Referring to FIGS. 3 to 6, the pedal having two treading surfaces of the present invention is illustrated. The pedal having two treading surfaces includes a pedal body 10, two retaining pieces 20, and an elastic positioning device 30.

The pedal body 10 has an H shape. A front end and a rear end of the pedal body 10 are formed as a receiving portion 11 for assembling two retaining pieces 20 and an elastic positioning device 30.

The two retaining pieces 20 are pivotally installed at the receiving portion 11 at two opposite sides of the pedal body 10 by respective screw rods 41. Each retaining piece 20 is formed by a plate integrally. Each retaining piece 20 has three operation surfaces, a first operation surface 21, a second operation surface 22, and a third operation surface 23. The first operation surface 21 and second operation surface 22 are at two opposite sides. A middle section of the first operation surface 21 is a main buckle 211 with a concave edge. Two sides of the main buckle 211 have two auxiliary buckles 212. The second operation surface 22 is bent as a stopper 221. The third operation surface 23 is between the first operation surface 21 and the second operation surface 22. A plurality of hollow portions 231 are formed in the third operation surface 23 and a through hole 232. The hollow portions 231 serves to reduce the weight of the retaining pieces 20. A screw 42 passes through the through hole 232. The two retaining pieces 20 are installed at two ends of the pedal body 10. The first operation surface 21 of one retaining piece 20 is parallel and opposite to the second operation surface 22 of another retaining piece 20.

The elastic positioning device 30 is formed by a positioning piece 31 and two elastomers 32. The positioning piece 31 is like a long strip. The positioning piece 31 is locked to the receiving portion 11 of the pedal body 10 by the screw 42. A screw rod 41 passes through the two elastomers 32 so that the two elastomers 32 are pivotally installed in the retaining piece 20. Two ends of each of the elastomer 32 are extended with a straight leg 321 and a bending leg 322. The straight leg 321 resists against the pedal body 10. The bending leg 322 hooks a lateral side of the positioning piece 31. Thereby, the retaining pieces 20 are confined elastically.

Thereby, by above mentioned components, in assembly of the present invention, the screw rod 41 is inserted into the pedal body 10 to be pivotally installed to the retaining piece 20 and the two elastomers 32. Then the pedal body 10 is turned up side down so that the positioning piece 31 is placed between the two elastomers 32 and thus the bending legs 322 hook lateral edges of the positioning piece 31. Then the screw 42 locks the structure. As a consequence, the pedal body 10 is assembled rapidly. Not only the assembly work is easy and quickly. Moreover, the cost can be reduced greatly.

Moreover, in the present invention, the main buckle of the first operation surface is slightly higher than the second operation surfaces.

Next, it should be noted that other than the retaining pieces 20, the elastic positioning device 30 is assembled between the retaining piece 20 and the pedal body 10. The pedal body 10 is unnecessary to be drilled so that the manufacturing and machining costs can be decreased.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A pedal having two treading surfaces comprising a pedal body, each of a front end and a rear end of the pedal body being installed with a retaining piece, and an elastic positioning device; wherein
the pedal body has an H shape; a front end and a rear end of the pedal body are formed as a receiving portion for assembling retaining pieces and an elastic positioning devices;
the two retaining pieces are pivotally installed at the receiving portion at two opposite sides of the pedal body by using respective screw rods; each retaining piece has three operation surfaces, a first operation surface, a second operation surface, and a third operation surface; the first operation surface and second operation surface are at two opposite sides; a middle section of the first operation surface is a main buckle with a concave edge; two sides of the main buckle have two auxiliary buckles; the second operation surface is bent as a stopper; the third operation surface is between the first operation surface and the second operation surface; a plurality of hollow portions are formed in the third operation surface and a through hole;
the elastic positioning device is formed by a positioning piece and two elastomers; the positioning piece is like a long strip; the positioning piece is locked to the receiving portion of the pedal body by the screw; a screw rod passes through the two elastomers so that the two elastomers are pivotally installed in the retaining piece; two ends of each of the elastomer are extended with a straight leg and a bending leg; the straight leg resists against the pedal body; the bending leg hooks a lateral side of the positioning piece; thereby, the retaining pieces are confined elastically;
wherein by above components, a pedal having two treading surfaces is assembled with less components.

2. The pedal having two treading surfaces as claimed in claim 1, wherein the main buckle of the first operation surface is slightly higher than the second operation surfaces.
